(19) United States
(12) Patent Application Publication
(10) Pub. No.: US 2026/0188726 A1
(43) Pub. Date: Jul. 2, 2026

(54) NON-AQUEOUS ELECTROLYTE SOLUTION AND LITHIUM-ION SECONDARY BATTERY

(71) Applicant: TDK Corporation, Tokyo (JP)

(72) Inventor: Ryosuke SUGIMOTO, Tokyo (JP)

(73) Assignee: TDK Corporation, Tokyo (JP)

(21) Appl. No.: 19/546,451

(22) Filed: Feb. 23, 2026

Related U.S. Application Data
(63) Continuation of application No. PCT/JP2025/027385, filed on Aug. 1, 2025.

(30) Foreign Application Priority Data
Sep. 2, 2024 (JP) 2024-150606

(51) Int. Cl. H01M 10/0525; H01M 4/02; H01M 4/133; H01M 4/134; H01M 4/36; H01M 4/38; H01M 4/583; H01M 4/62; H01M 10/0568; H01M 10/0569

(52) U.S. Cl. CPC H01M 10/0525; H01M 4/133; H01M 4/134; H01M 4/364; H01M 4/386; H01M 4/583; H01M 4/623; H01M 4/625; H01M 10/0568; H01M 10/0569; H01M 2004/021; H01M 2004/027; H01M 2300/0034; H01M 2300/004; H01M 2300/0051

(57) ABSTRACT

A non-aqueous electrolyte solution includes lithium hexafluorophosphate, lithium bis(fluorosulfonyl)imide, and lithium nitrate. In the non-aqueous electrolyte solution, a molar ratio of the lithium nitrate relative to a molar ratio of the lithium hexafluorophosphate is 0.01 or more and 0.15 or less, and a molar ratio of the lithium bis(fluorosulfonyl)imide relative to a molar ratio of the lithium hexafluorophosphate is 0.1 or more and 1.0 or less.

### CROSS-REFERENCE TO RELATED APPLICATIONS

The present application claims priority to International Application No. PCT/JP2025/027385, filed Aug. 1, 2025, and Japanese Patent Application No. 2024-150606, filed on Sep. 2, 2024, the entire contents of each are incorporated herein by reference.

### BACKGROUND

### Field

The present disclosure relates to a non-aqueous electrolyte solution and a lithium-ion secondary battery.

### Description of Related Art

Lithium-ion secondary batteries are in wide use as power sources for mobile devices, such as mobile phones and notebook computers, hybrid cars, and the like.

A variety of studies have been conducted to improve the performances of lithium-ion secondary batteries. One of the characteristics that are demanded for lithium-ion secondary batteries is the cycle characteristics. When charged and discharged a plurality of times, lithium-ion secondary batteries deteriorate. The cycle characteristics are the capacity retention of a lithium-ion secondary battery that has been charged and discharged a plurality of times with respect to the lithium-ion secondary battery that has been initially charged and discharged. When an electrolytic solution decomposes on the surface of a negative electrode, the cycle characteristics of the lithium-ion secondary battery deteriorate.

For example, Patent Document 1 discloses that when a non-aqueous electrolyte containing a predetermined lithium salt and predetermined glyme is used, the cycle characteristics of a lithium-ion secondary battery improve.

### PATENT DOCUMENTS

[Patent Document 1] Japanese Unexamined Patent Application, First Publication No. 2018-67501

### SUMMARY

Even in the case of using the non-aqueous electrolyte solution described in Patent Document 1, there is a case where sufficient cycle characteristics are not exhibited along with an increase in the number of times of charging and discharging. In addition, lithium-ion secondary batteries are often used in a variety of environments and may operate as appropriate at low temperatures and at high temperatures. Therefore, there is a demand for a lithium-ion secondary battery exhibiting sufficient cycle characteristics at low temperatures and at high temperatures.

The present disclosure has been made in consideration of the above-described problem, and one or more embodiments may provide a lithium-ion secondary battery having excellent cycle characteristics at both low temperatures and high temperatures and a non-aqueous electrolyte solution that is used in the lithium-ion secondary battery.

In order to achieve the excellent cycle characteristics at both low temperatures and high temperatures, the following means is provided.
(1) A non-aqueous electrolyte solution according to a first aspect contains lithium hexafluorophosphate, lithium bis(fluorosulfonyl)imide, and lithium nitrate. In the non-aqueous electrolyte solution according to the first aspect, a molar ratio of the lithium nitrate relative to a molar ratio of the lithium hexafluorophosphate is 0.01 or more and 0.15 or less, and a molar ratio of the lithium bis(fluorosulfonyl)imide relative to a molar ratio of the lithium hexafluorophosphate is 0.1 or more and 1.0 or less.
(2) A lithium-ion secondary battery according to a second aspect has a positive electrode, a negative electrode, a separator between the positive electrode and the negative electrode, and the non-aqueous electrolyte solution according to the above-described aspect.
(3) In the lithium-ion secondary battery according to the above-described aspect, an S2p spectrum that is obtained by measuring a surface of the negative electrode using X-ray photoelectron spectroscopy (XPS) may have a first peak that is observed in a binding energy range of 165 eV or higher and 175 eV or lower and a second peak that is observed in a binding energy range of 155 eV or higher and 165 eV or lower. An intensity ratio of the second peak to the first peak may be 0.5 or more and less than 4.0.
(4) In the lithium-ion secondary battery according to the above-described aspect, an F1s spectrum that is obtained by measuring a surface of the negative electrode using X-ray photoelectron spectroscopy (XPS) may have a third peak that is observed in a binding energy range of 686 eV or higher and 690 eV or lower and a fourth peak that is observed in a binding energy range of 682 eV or higher and 686 eV or lower. An intensity ratio of the fourth peak to the third peak may be 1.5 or more and less than 4.0.
(5) In the lithium-ion secondary battery according to the above-described aspect, a C1s spectrum that is obtained by measuring a surface of the negative electrode using X-ray photoelectron spectroscopy (XPS) may have a fifth peak that is observed in a binding energy range of 288 eV or higher and 292 eV or lower and a sixth peak that is observed in a binding energy range of 280 eV or higher and 288 eV or lower. An intensity ratio of the sixth peak to the fifth peak may be 2.0 or more and less than 5.0.
(6) In the lithium-ion secondary battery according to the above-described aspect, the negative electrode may have a negative electrode active material layer containing a negative electrode active material. The negative electrode active material may contain at least one of a silicon material particle and a graphite particle. A volume ratio of the silicon material particle to the negative electrode active material may be 10 vol % or more and 100 vol % or less.
(7) In the lithium-ion secondary battery according to the above-described aspect, the negative electrode may have a negative electrode active material layer containing a silicon material particle. A weight ratio of a silicon element to the negative electrode active material layer may be 1 wt % or more and 50 wt % or less.

A lithium-ion secondary battery in which the non-aqueous electrolyte solution according to the above-described aspect is used has excellent cycle characteristics at both low temperatures and high temperatures.

### BRIEF DESCRIPTION OF THE DRAWINGS

FIG. 1 is a schematic view of a lithium-ion secondary battery according to an embodiment.

FIG. 2 is an S2p spectrum obtained when the surface of a negative electrode of the lithium-ion secondary battery according to the first embodiment is measured using X-ray photoelectron spectroscopy (XPS).

FIG. 3 is an F1s spectrum obtained when the surface of the negative electrode of the lithium-ion secondary battery according to the first embodiment is measured using X-ray photoelectron spectroscopy (XPS).

FIG. 4 is a C1s spectrum obtained when the surface of the negative electrode of the lithium-ion secondary battery according to the first embodiment is measured using X-ray photoelectron spectroscopy (XPS).

### DETAILED DESCRIPTION

Hereinafter, an embodiment will be described in detail with reference to drawings as appropriate. In the drawings to be used in the following description, there are cases where a characteristic portion is illustrated in an enlarged manner for convenience to facilitate the understanding of the characteristics, and the dimensional ratio and the like of each component may be different from actual ones. Materials, dimensions, and the like to be exemplified in the following description are simply examples, and the embodiments are not limited thereto and can be appropriately modified and carried out within the scope of the gist thereof.

### “Lithium-Ion Secondary Battery”

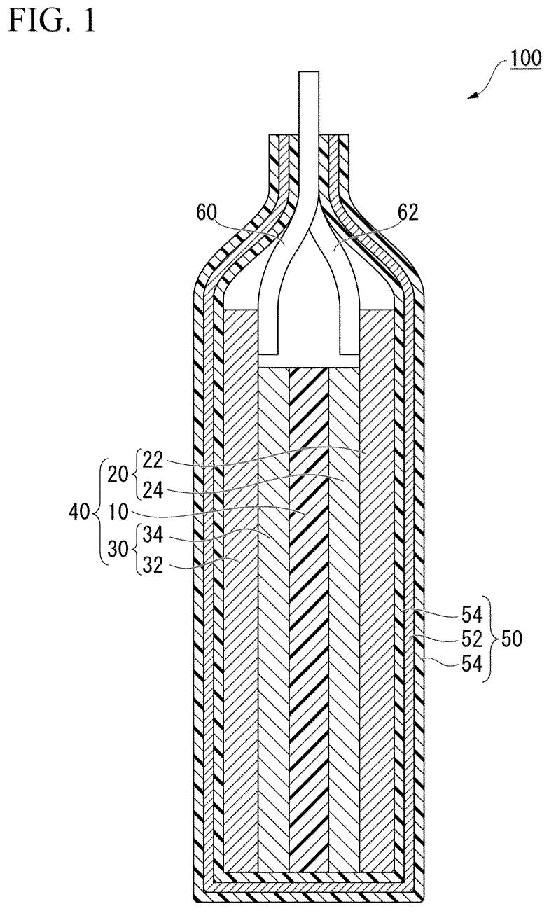

FIG. 1 is a schematic view of a lithium-ion secondary battery according to an embodiment. A lithium-ion secondary battery 100 illustrated in FIG. 1 includes a power generation element 40, an exterior body 50, and a non-aqueous electrolyte solution. The exterior body 50 covers the periphery of the power generation element 40. The power generation element 40 is connected to the outside with a pair of terminals 60 and 62 connected to the power generation element 40. The non-aqueous electrolyte solution is contained in the exterior body 50. In an implementation, as illustrated in FIG. 1, the exterior body 50 may include one power generation element 40, or a plurality of power generation elements 40 may be laminated together. In addition, the lithium-ion secondary battery 100 may have any of a cylindrical shape, a square shape, a laminate shape, a button shape, or the like.

### (Power Generation Element)

The power generation element 40 includes a separator 10, a positive electrode 20, and a negative electrode 30.

### <Positive Electrode>

The positive electrode 20 has, for example, a positive electrode current collector 22 and a positive electrode active material layer 24. The positive electrode active material layer 24 is in contact with at least one surface of the positive electrode current collector 22.

### [Positive Electrode Current Collector]

The positive electrode current collector 22 is, for example, a conductive plate material. The positive electrode current collector 22 is, for example, a thin metal plate of aluminum, copper, nickel, titanium, stainless steel, or the like. Lightweight aluminum is suitably used for the positive electrode current collector 22. The average thickness of the positive electrode current collector 22 is, for example, 10 μm or more and 30 μm or less. The positive electrode current collector 22 may be an expanded membrane or a punched membrane.

### [Positive Electrode Active Material Layer]

The positive electrode active material layer 24 contains, for example, a positive electrode active material. In an implementation, the positive electrode active material layer 24 may contain a conductive aid and a binder.

The positive electrode active material includes electrode active materials capable of the reversible progression of the absorption and release of lithium ions, the intercalation and deintercalation of lithium ions (intercalation), or the doping and de-doping of lithium ions and counter anions.

The positive electrode active material is, for example, a composite metal oxide. The composite metal oxide is, for example, lithium cobalt oxide (LiCoO₂), lithium nickel oxide (LiNiO₂), lithium manganese oxide (LiMnO₂), lithium manganese spinel (LiMn₂O₄), compounds of a general formula: LiNiₓCo_{y}Mn_{z}MₐO₂ (wherein x+y+z+a=1, 0≤x<1, 0≤y<1, 0≤z<1, 0≤a<1, and M is one or more elements selected from Al, Mg, Nb, Ti, Cu, Zn, and Cr), lithium vanadium compounds (LiV₂O₅), olivine-type LiMPO₄ (wherein M indicates one or more elements selected from Co, Ni, Mn, Fe, Mg, Nb, Ti, Al, and Zr or VO), lithium titanium oxide (Li₄Ti₅O₁₂), or LiNiₓCo_{y}Al₂O₂ (0.9<x+y+z<1.1). As the compounds represented by the general formula: LiNiₓCo_{y}Mn_{z}MₐO₂, it is possible to use, for example, one or more selected from LiNi_{0.92}Co_{0.04}Mn_{0.04}O₂, LiNi_{0.9}Co_{0.05}Mn_{0.05}O₂, LiNi_{0.8}Co_{0.1}Mn_{0.1}O₂, LiNi_{0.6}Co_{0.2}Mn_{0.2}O₂, LiNi_{0.9}Co_{0.05}Mn_{0.05}O₂, LiNi_{0.6}Co_{0.2}Mn_{0.1}Al_{0.1}O₂, LiNi_{0.6}Co_{0.2}Mn_{0.15}Al_{0.05}O₂, LiNi_{0.7}Co_{0.1}Mn_{0.1}Al_{0.1}O₂, LiNi_{0.7}Mn_{1.3}O₄, LiNi_{0.5}Mn_{1.5}O₄, LiNi_{0.3}Mn_{1.7}O₄, or the like. The positive electrode active material may be an organic substance. For example, the positive electrode active material may be polyacetylene, polyaniline, polypyrrole, polythiophene, or polyacene.

The positive electrode active material may be a lithium-free material. The lithium-free material is, for example, FeF₃, a conjugated polymer containing an organic conductive substance, a Chevrel phase compound, a transition metal chalcogenide, a vanadium oxide, a niobium oxide, or the like. As the lithium-free material, any one material alone may be used or a plurality of materials may be used in combination. In a case where the positive electrode active material is the lithium-free material, for example, the lithium-ion secondary battery is discharged first. Lithium ions are intercalated into the positive electrode active material by discharging. Besides, the positive electrode active material may chemically or electrochemically pre-dope lithium into the lithium-free material.

The conductive aid enhances the electron conductivity within the positive electrode active material. The conductive aid is, for example, a carbon powder, carbon nanotubes, a carbon material, a fine metal powder, a mixture of a carbon material and a fine metal powder, or a conductive oxide. The carbon powder is, for example, carbon black, acetylene black, ketjen black, or the like. The fine metal powder is, for example, a powder of copper, nickel, stainless steel, iron, or the like.

In an implementation, the content of the conductive aid in the positive electrode active material layer 24 may be a suitable content. In an implementation, the content of the conductive aid relative to the total mass of the positive electrode active material, the conductive aid, and the binder is 0.5 mass % or more and 20 mass % or less, e.g., 1 mass % or more and 5 mass % or less.

The binder in the positive electrode active material layer 24 binds the positive electrode active material together. As the binder, a suitable binder can be used. As the binder, an oxidation-resistant and adhesive binder that does not dissolve in electrolytic solutions may be used. The binder is, for example, a fluororesin. The binder is, for example, polyvinylidene fluoride (PVDF), polytetrafluoroethylene (PTFE), polyamide (PA), polyimide (PI), polyamide-imide (PAI), polybenzimidazole (PBI), polyethersulfone (PES), a polyacrylic acid or a copolymer thereof, a metal ion cross-linked polyacrylic acid or a copolymer thereof, polypropylene (PP) or polyethylene (PE) to which a maleic anhydride has been grafted, or a mixture thereof. In an implementation, the binder that is used in the positive electrode active material layer may be PVDF.

The binder may be included in the positive electrode active material layer 24 in a suitable amount. For example, the content of the binder relative to the total mass of the positive electrode active material, the conductive aid, and the binder is 1 mass % or more and 15 mass % or less, e.g., 1.5 mass % or more and 5 mass % or less. When the content of the binder is small, the adhesive strength of the positive electrode 20 weakens. When the content of the binder is high, since the binder is electrochemically inactive and does not contribute to the discharge capacity, the energy density of the lithium-ion secondary battery 100 becomes low.

### <Negative Electrode>

The negative electrode 30 has, for example, a negative electrode current collector 32 and a negative electrode active material layer 34. The negative electrode active material layer 34 is in contact with at least one surface of the negative electrode current collector 32. The negative electrode 30 is one example of a negative electrode for lithium-ion secondary batteries.

### [Negative Electrode Current Collector]

The negative electrode current collector 32 is, for example, a conductive plate material. As the negative electrode current collector 32, it is possible to use the same electrode current collector as the positive electrode current collector 22. The negative electrode current collector 32 may be an expanded membrane or a punched membrane.

### [Negative Electrode Active Material Layer]

The negative electrode active material layer 34 contains, for example, a negative electrode active material. In an implementation, the negative electrode active material layer 34 may contain a binder, a conductive aid, or the like.

The negative electrode active material may be a compound capable of absorbing and releasing ions, and a negative electrode active material that is suitably used in lithium-ion secondary batteries can be used. The negative electrode active material is, for example, metallic lithium, a lithium alloy, a carbon material, or a substance capable of forming an alloy with lithium. The carbon material is, for example, graphite (natural graphite or artificial graphite) capable of absorbing and releasing ions, carbon nanotubes, non-graphitizable carbon, easily graphitized carbon, low-temperature fired carbon, or the like. The substance capable of forming an alloy with lithium is, for example, silicon, tin, zinc, lead, or antimony. The substance capable of forming an alloy with lithium may be, for example, a pure metal thereof or an alloy or oxide containing these elements. In addition, the substance capable of forming an alloy with lithium may be a complex having a surface that is at least partially covered with a conductive material (for example, a carbon material) or the like.

The negative electrode active material may contain, for example, at least one of a silicon-containing compound or material (e.g., a silicon material) particle and a graphite particle. The negative electrode active material may be a silicon material particle alone. The silicon material particle may be pure Si, SiC, SiOₓ (x satisfies, for example, 0.8≤x≤2.0), or MSi (Mis an alkaline earth metal or a transition metal). As used herein, the term “or” is not necessarily an exclusive term, e.g., “A or B” would include A, B, or A and B.

In the negative electrode active material, the volume ratio or amount of the silicon material particle may be 10 vol % or more and 100 vol % or less, may be 10 vol % or more and less than 100 vol %, or may be 10 vol % or more and 50.5 vol % or less, based on a total volume of the negative electrode active material. For example, in a case where the negative electrode active material is composed of a silicon material particle and a graphite particle, the total volume ratio thereof reaches 100 vol %.

The volume ratio of the silicon material particle to the negative electrode active material is obtained by the following procedure. First, the negative electrode active material layer is divided into three parts in the thickness direction and classified into an upper layer, a middle layer, and a lower layer. In addition, in each of the upper layer, the middle layer, and the lower layer, cross-sectional SEM (scanning electron microscope) images are captured at three different sites on the surface. The cross-sectional SEM images are measured at a total of nine sites. From each of the cross-sectional SEM images, the negative electrode active material is extracted. The negative electrode active material can be extracted using a difference in contrast on the images. Next, the silicon material particles are extracted from the negative electrode active material. The silicon material particles may be extracted using a difference in contrast on the images or extracted using a composition analysis for which EDX (energy dispersive X-ray spectroscopy) or the like is used. In addition, on each image, the area ratios of the silicon material particles relative to the negative electrode active material are obtained, and the average value thereof is obtained. Since the cross-sectional SEM images are measured on an arbitrary surface, the area ratio on the cross-sectional SEM image substantially coincides with the overall volume ratio. Therefore, this average value is regarded as the volume ratio of the silicon material particles to the negative electrode active material.

In addition, in the negative electrode active material layer 34, the weight ratio or amount of a silicon element may be 1 wt % or more and 50 wt % or less or may be 1 wt % or more and 10.2 wt % or less, based on 100 wt % of the negative electrode active material layer 34. The weight ratio of a silicon element can be measured using X-ray fluorescence (XRF). Three different points on the surface of the negative electrode active material layer 34 are measured by XRF, and the average of the silicon element ratios calculated at the three points, respectively, is calculated, whereby the weight ratio of the silicon element to the negative electrode active material layer 34 is obtained. The intervals between the measurement points at the time of XRF measurement is set to be wider than a measuring sphere (the beam diameter that is used in the measurement). For example, in a case where the beam diameter is 1.2 mm, the distance between adjacent points out of the three points to be measured is set to more than 1.2 mm. As the conductive aid and the binder that are used in the negative electrode active material layer 34, the same conductive aid and binder as in the positive electrode active material layer 24 can be used.

In an implementation, the binder may be included in the negative electrode active material layer 34 in a suitable amount. In an implementation, the content of the binder relative to the total mass of the negative electrode active material, the conductive aid, and the binder is 0.5 mass % or more and 20 mass % or less, e.g., 5 mass % or more and 15 mass % or less. When the content of the binder is small, the adhesive strength of the negative electrode 30 weakens. When the content of the binder is high, since the binder 1 is electrochemically inactive and does not contribute to the discharge capacity, the energy density of the lithium-ion secondary battery 100 becomes low.

The conductive aid in the negative electrode active material layer 34 enhances the electron conductivity between the negative electrode active material. As the conductive aid, the same conductive aid as in the positive electrode active material layer 24 can be used.

In an implementation, the conductive aid may be included in the negative electrode active material layer 34 in a suitable amount. In an implementation, the content of the conductive aid relative to the total mass of the negative electrode active material, the conductive aid, and the binder is 5 mass % or more and 20 mass % or less, e.g., 1 mass % or more and 12 mass % or less.

### <Separator>

The separator 10 is sandwiched between the positive electrode 20 and the negative electrode 30. The separator 10 isolates the positive electrode 20 and the negative electrode 30 and prevents a short circuit between the positive electrode 20 and the negative electrode 30. The separator 10 spreads along the surfaces of the positive electrode 20 and the negative electrode 30. Lithium ions are capable of passing through the separator 10.

The separator 10 has, for example, an electrically insulating porous structure. The separator 10 is, for example, a single-layer polyolefin film or a laminate of polyolefin films. The separator 10 may be a stretched membrane of a mixture of polyethylene, polypropylene, or the like. The separator 10 may be a fiber nonwoven fabric including cellulose, polyester, polyacrylonitrile, polyamide, polyethylene, or polypropylene. The separator 10 may be, for example, a solid electrolyte. The solid electrolyte is, for example, a polymer solid electrolyte, an oxide solid electrolyte, or a sulfide solid electrolyte. The separator 10 may be an inorganic coated separator. The inorganic coated separator is a separator obtained by applying a mixture of a resin, such as PVDF or CMC, and an inorganic substance, such as alumina or silica, to the surface of the above-described film. The inorganic coated separator has excellent heat resistance and curbs the precipitation of the transition metal eluted from the positive electrode on the surface of the negative electrode.

### <Non-Aqueous Electrolyte Solution>

A non-aqueous electrolyte solution is enclosed in the exterior body 50, and the power generation element 40 is impregnated with the non-aqueous electrolyte solution. The non-aqueous electrolyte solution contains, for example, a non-aqueous solvent and an electrolytic salt. The electrolytic salt is in a state of being dissolved in the non-aqueous solvent.

The non-aqueous solvent is, for example, an aprotic organic solvent. The organic solvent is, for example, a cyclic carbonate, a linear carbonate, an ether, a mixture thereof, or the like. In an implementation, the solvent may be an ionic liquid.

The cyclic carbonate solvates an electrolyte. The cyclic carbonate is, for example, ethylene carbonate, propylene carbonate, butylene carbonate, or fluoroethylene carbonate. In an implementation, the cyclic carbonate may include fluoroethylene carbonate. Fluoroethylene carbonate (FEC) has a high redox potential and is likely to be reduced and decomposed. When fluoroethylene carbonate (FEC) is partially reduced and decomposed, an electrolyte or the remaining solvent in an electrolytic solution is unlikely to be decomposed. In addition, fluoroethylene carbonate (FEC) forms a stable film (SEI film) on the entire surface of the negative electrode active material during the initial use of the lithium-ion secondary battery. The SEI film prevents the direct contact between the negative electrode active material and the electrolytic solution and prevents the decomposition of the electrolytic solution.

The linear carbonate decreases the viscosity of the cyclic carbonate. The linear carbonate is, for example, diethyl carbonate, dimethyl carbonate, or ethyl methyl carbonate. The non-aqueous solvent may contain, additionally, methyl acetate, ethyl acetate, methyl propionate, ethyl propionate, propyl propionate, γ-butyrolactone, 1,2-dimethoxyethane, 1,2-diethoxyethane, or the like.

The non-aqueous electrolyte solution contains, as the electrolytic salt, lithium hexafluorophosphate (LiPF₆), lithium bis(fluorosulfonyl)imide (LiFSI), and lithium nitrate (LiNO₃). The molar ratio of lithium nitrate relative to the molar ratio of lithium hexafluorophosphate is 0.01 or more and 0.15 or less. In addition, the molar ratio of lithium bis(fluorosulfonyl)imide relative to the molar ratio of lithium hexafluorophosphate is 0.1 or more and 1.0 or less.

When the non-aqueous electrolyte solution contains three kinds of electrolytic salts at the above-described ratios, a film (SEI film) having a sufficient film thickness and not significantly inhibiting the Li ion transfer is formed on the surface of the negative electrode 30 (the negative electrode active material layer 34). The film is formed on the surface of the negative electrode 30 (the negative electrode active material layer 34) by the reductive decomposition of a part of the non-aqueous electrolyte solution. The film inhibits additional decomposition of the non-aqueous electrolyte solution.

When the film does not have a sufficient thickness, there is an increasing possibility that the non-aqueous electrolyte solution and the negative electrode 30 may come into contact with each other and the non-aqueous electrolyte solution may decompose. The decomposition of the non-aqueous electrolyte solution is one of the reasons for the deterioration of the cycle characteristics. In addition, when the lithium-ion secondary battery operates at a high temperature, there is a case where the film decomposes due to heat. When there is a film having a sufficient film thickness on the surface of the negative electrode, the cycle characteristics of the lithium-ion secondary battery are unlikely to deteriorate even when the lithium-ion secondary battery operates at high temperatures.

In addition, when the film significantly inhibits the migration of Li, Li is precipitated on the surface of the film. When a Li dendrite is generated on the surface of the film, the cycle characteristics of the lithium-ion secondary battery deteriorate. When the lithium-ion secondary battery operates at low temperatures, lithium ions are less likely to migrate and the precipitation of Li is more likely to occur than when the lithium-ion secondary battery operates at high temperatures. When the non-aqueous electrolyte solution contains three kinds of electrolytic salts at the above-described ratios, the film is unlikely to be highly resistive, and the cycle characteristics of the lithium-ion secondary battery are unlikely to deteriorate even when the lithium-ion secondary battery operates at low temperatures.

The chemical binding state of the film can be analyzed by measuring the surface of the negative electrode 30 using X-ray photoelectron spectroscopy (XPS).

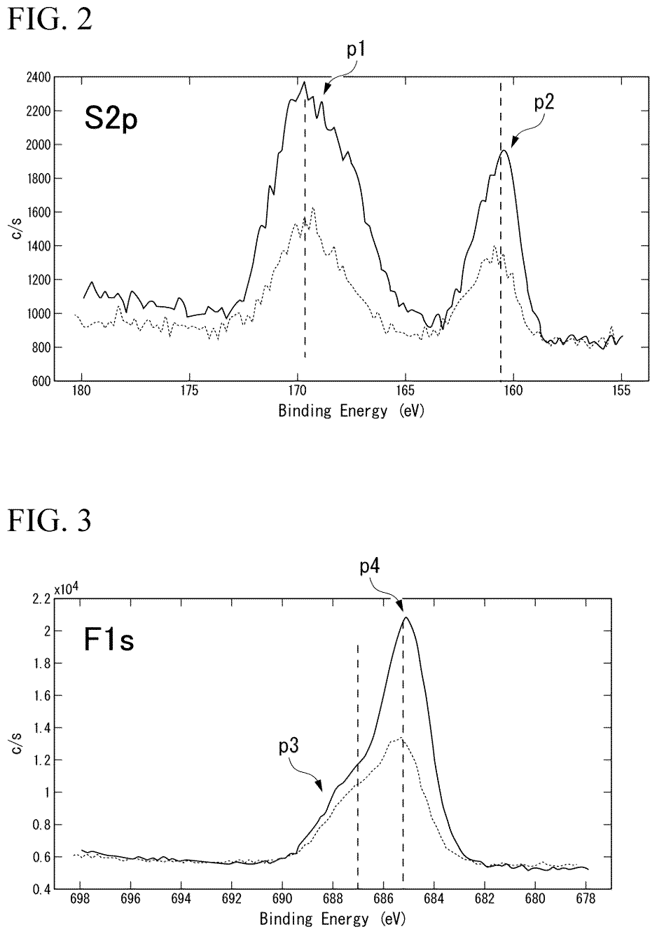

FIG. 2 is an S2p spectrum obtained when the surface (film) of the negative electrode 30 is measured using X-ray photoelectron spectroscopy (XPS). The solid line in FIG. 2 is a result in a case where the non-aqueous electrolyte solution contains lithium hexafluorophosphate (LiPF₆), lithium bis(fluorosulfonyl)imide (LiFSI), and lithium nitrate (LiNO₃) in the above-described predetermined ratios. The dotted line in FIG. 2 is a result in a case where the non-aqueous electrolyte solution contains lithium hexafluorophosphate (LiPF₆) and lithium bis(fluorosulfonyl)imide (LiFSI) but does not contain lithium nitrate (LiNO₃).

The S2p spectrum has a first peak p1 that is observed in a binding energy range of 165 eV or higher and 175 eV or lower and a second peak p2 that is observed in a binding energy range of 155 eV or higher and 165 eV or lower. Hereinafter, ordinal numbers that indicate peaks, such as the first peak p1, are simply reference signs for differentiating peaks and do not have any relationship with the degrees of the intensities of the peaks. The first peak is a peak derived from SO₄²⁻, and the second peak is a peak derived from S²⁻.

The intensity ratio of the second peak p2 to the first peak p1 may be 0.5 or more and less than 4.0. Here, the intensity ratio between the first peak p1 and the second peak p2 is a result on the surface of the negative electrode 30 of the lithium-ion secondary battery 100 after 100 cycles. When the intensity ratio of the second peak p2 to the first peak p1 is 0.5 or more, the thickness of a film having a SO₄ bond is sufficient, and the thermal decomposition of the film is unlikely to occur even under high-temperature environments. In addition, when the intensity ratio of the second peak p2 to the first peak p1 is less than 4.0, the resistance of the film against lithium ions is small, and the precipitation of Li can be curbed even under low-temperature environments.

FIG. 3 is an F1s spectrum obtained when the surface (film) of the negative electrode 30 is measured using X-ray photoelectron spectroscopy (XPS). The solid line in FIG. 3 is a result in a case where the non-aqueous electrolyte solution contains lithium hexafluorophosphate (LiPF₆), lithium bis(fluorosulfonyl)imide (LiFSI), and lithium nitrate (LiNO₃) in the above-described predetermined ratios. The dotted line in FIG. 3 is a result in a case where the non-aqueous electrolyte solution contains lithium hexafluorophosphate (LiPF₆) and lithium bis(fluorosulfonyl)imide (LiFSI) but does not contain lithium nitrate (LiNO₃).

The F1s spectrum has a third peak p3 that is observed in a binding energy range of 686 eV or higher and 690 eV or lower and a fourth peak p4 that is observed in a binding energy range of 682 eV or higher and 686 eV or lower. The third peak p3 is a peak derived from a C—F bond, and the fourth peak p4 is a peak derived from a Li—F bond.

The intensity ratio of the fourth peak p4 to the third peak p3 may be 1.5 or more and less than 4.0. Here, the intensity ratio between the fourth peak p4 and the third peak p3 is a result on the surface of the negative electrode 30 of the lithium-ion secondary battery 100 after 100 cycles. In a case where the fourth peak p4 and the third peak p3 partially overlap each other, as illustrated in FIG. 3, peak separation from the spectrum is performed. The peak separation can be performed with XPS software. Specifically, the peak separation is performed by the following procedure. A composite wave is created based on a composition function for which Gaussian function and Lorentzian function are used, and the composite wave is compared with a measured waveform. The composite wave is corrected so that the difference between both is minimized to perform the fitting of the composite wave and the measured waveform, and an optimal waveform for synthesizing the measured waveform is obtained.

When the intensity ratio of the fourth peak p4 to the third peak p3 is 1.5 or more, the thickness of a film having Li—F is sufficient, and the thermal decomposition of the film is unlikely to occur even under high-temperature environments. In addition, when the intensity ratio of the fourth peak p4 to the third peak p3 is less than 4.0, the resistance of the film against lithium ions is small, and the precipitation of Li can be curbed even under low-temperature environments.

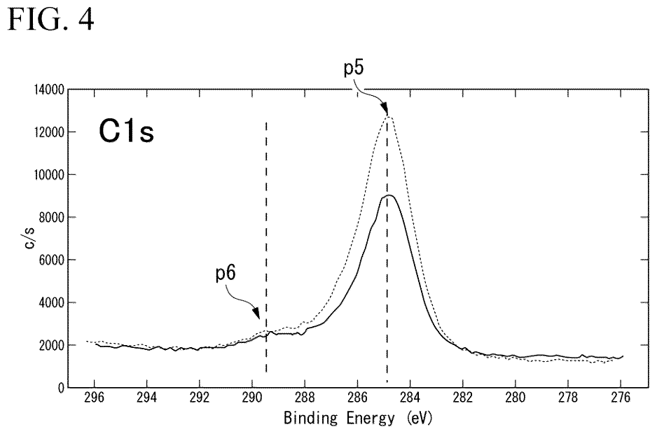

FIG. 4 is a C1s spectrum obtained when the surface (film) of the negative electrode 30 is measured using X-ray photoelectron spectroscopy (XPS). The solid line in FIG. 4 is a result in a case where the non-aqueous electrolyte solution contains lithium hexafluorophosphate (LiPF₆), lithium bis(fluorosulfonyl)imide (LiFSI), and lithium nitrate (LiNO₃) in the above-described predetermined ratios. The dotted line in FIG. 4 is a result in a case where the non-aqueous electrolyte solution contains lithium hexafluorophosphate (LiPF₆) and lithium bis(fluorosulfonyl)imide (LiFSI) but does not contain lithium nitrate (LiNO₃).

The C1s spectrum has a fifth peak p5 that is observed in a binding energy range of 288 eV or higher and 292 eV or lower and a sixth peak p6 that is observed in a binding energy range of 280 eV or higher and 288 eV or lower. The fifth peak p5 is a peak derived from a C—F bond, and the sixth peak p6 is a peak derived from a C—C bond or a C—H bond.

The intensity ratio of the sixth peak p6 to the fifth peak p5 may be 2.0 or more and less than 5.0. Here, the intensity ratio between the sixth peak p6 and the fifth peak p5 is a result on the surface of the negative electrode 30 of the lithium-ion secondary battery 100 after 100 cycles.

When the intensity ratio of the sixth peak p6 to the fifth peak p5 is 2.0 or more, a film containing alkyl lithium and having a relatively high molecular weight can be obtained, and this film covers the surface of the negative electrode, whereby the contact between the electrolytic solution and the negative electrode can be curbed. In addition, when the intensity ratio of the sixth peak p6 to the fifth peak p5 is less than 5.0, a film containing carbon and fluorine and having small resistance to lithium ions is formed, and the precipitation of Li can be curbed even under low-temperature environments.

In an implementation, the non-aqueous electrolyte solution may contain an SEI film-forming material, a surfactant, or the like. An additive is, for example, vinylene carbonate, vinylethylene carbonate, phenylethylene carbonate, a succinic anhydride, lithium bisoxalate, lithium tetrafluoroborate, a dinitrile compound, propane sultone, butane sultone, propene sultone, 3-sulfolene, fluorinated allyl ether, fluorinated acrylate, or the like.

### <Exterior Body>

The exterior body 50 seals the power generation element 40 and the non-aqueous electrolyte solution therein. The exterior body 50 prevents the leakage of the non-aqueous electrolyte solution to the outside, the intrusion of moisture or the like into the lithium-ion secondary battery 100 from the outside, and the like.

The exterior body 50 has, for example, as illustrated in FIG. 1, a metal foil 52 and resin layers 54 laminated on the individual surfaces of the metal foil 52. The exterior body 50 is a metal laminate film having the metal foil 52 coated with polymer films (the resin layers 54) from both sides.

As the metal foil 52, for example, an aluminum foil can be used. As the resin layer 54, a polymer film of polypropylene or the like can be used. The resin layer 54 may be composed of different materials on the inside and on the outside. In an implementation, a polymer having a high melting point, for example, polyethylene terephthalate (PET) or polyamide (PA), can be used as the outside material, and polyethylene (PE), polypropylene (PP), or the like can be used as the inside material.

### <Terminals>

The terminals 60 and 62 are connected to the negative electrode 30 and the positive electrode 20, respectively. The terminal 62 connected to the positive electrode 20 is a positive electrode terminal, and the terminal 60 connected to the negative electrode 30 is a negative electrode terminal. The terminals 60 and 62 assume electrical connection with the outside. The terminals 60 and 62 are formed of a conductive material, such as aluminum, nickel, or copper. A connection method may be welding or screw fastening. The terminals 60 and 62 may be protected with insulating tape in order to prevent a short circuit.

### “Method for Manufacturing Lithium-Ion Secondary Battery”

The lithium-ion secondary battery 100 is produced by preparing the negative electrode 30, the positive electrode 20, the separator 10, the non-aqueous electrolyte solution, and the exterior body 50, respectively, and combining these together. Hereinafter, one example of a method for manufacturing the lithium-ion secondary battery 100 will be described.

The positive electrode 20 is produced by performing, for example, a slurry production step, an electrode application step, a drying step, and a rolling step in order. The slurry production step is a step of making a slurry by mixing the positive electrode active material, the conductive aid, and the binder in a solvent. The solvent is, for example, water, N-methyl-2-pyrrolidone, or the like.

The electrode application step is a step of applying the slurry to the surface of the positive electrode current collector 22. A method for applying the slurry may include a suitable method. For example, a slit die coating method or a doctor blade method can be used as the method for applying the slurry. The slurry is applied at, for example, room or ambient temperature.

The drying step is a step of removing the solvent from the slurry. For example, the positive electrode current collector 22 to which the slurry has been applied is dried under an environment of 80° C. to 350° C.

In an implementation, the rolling step is performed. The rolling step is a step of applying a pressure to the positive electrode active material layer 24 to adjust the density of the positive electrode active material layer 24. The rolling step is performed with, for example, a roll press machine or the like.

The negative electrode 30 can be produced by the same procedure for the positive electrode 20. As the separator 10 and the exterior body 50, suitable commercially available products can be used.

Next, the positive electrode 20, the separator 10, and the negative electrode 30 are laminated together such that the separator 10 is positioned between the produced positive electrode 20 and negative electrode 30, thereby producing the power generation element 40. The terminal 62 is connected to the positive electrode 20 of the power generation element 40, and the terminal 60 is connected to the negative electrode 30. In a case where the power generation element 40 is a wound body, the positive electrode 20, the negative electrode 30, and the separator 10 are wound around one end side of the positive electrode 20, the negative electrode 30, and the separator 10 as the axis.

Next, the power generation element 40 is enclosed in the exterior body 50. The non-aqueous electrolyte solution is poured or otherwise provided into the exterior body 50. After the non-aqueous electrolyte solution is poured into the exterior body 50, the exterior body is decompressed, and the non-aqueous electrolyte solution is heated, whereby the power generation element 40 is impregnated with the non-aqueous electrolyte solution. The exterior body 50 is sealed by applying heat or the like thereto. Instead of pouring the non-aqueous electrolyte solution into the exterior body 50, the power generation element 40 may be impregnated with the non-aqueous electrolyte solution. After the non-aqueous electrolyte solution is injected into the power generation element 40, the power generation element 40 may be left to stand for 24 hours.

Next, the power generation element 40 is charged and discharged for the first time. During this initial charging, a film is formed on the surface of the negative electrode 30.

At the time of forming the film, the non-aqueous electrolyte solution may be heated within a temperature range of 50° C. to 70° C. for approximately two hours after being poured into the exterior body 50. This treatment helps make the intensity ratio of the second peak p2 to the first peak p1 be 0.5 or more and less than 4.0.

In addition, at the time of forming the film, as the initial charging treatment, the power generation element 40 may be charged in two stages at different charging rates and held under each of the charging rate conditions for a certain time. For example, the power generation element 40 is charged for two hours by constant-current charging at a charging rate of 0.1 C (a current value at which the power generation element 40 is completely charged within one hour when constant-current charged at 25° C.) and then charged at a charging rate of 0.2 C until the battery voltage reaches 4.3 V, and furthermore, the subsequent constant voltage state at 4.3 V is held for 10 minutes or longer. This treatment helps make the intensity ratio of the fourth peak p4 to the third peak p3 be 1.5 or more and less than 4.0.

At the time of forming the film, the power generation element 40 may be charged within a temperature range of 20° C. to 30° C. This treatment helps make the intensity ratio of the sixth peak p6 to the fifth peak p5 be 2.0 or more and less than 5.0.

The power generation element 40 is charged and discharged for the first time, whereby the film is formed on the surface of the negative electrode 30, and the lithium-ion secondary battery 100 according to the present embodiment can be obtained.

The lithium-ion secondary battery 100 according to the present embodiment has excellent cycle characteristics both under low-temperature environments and under high-temperature environments. This is because the non-aqueous electrolyte solution contains the predetermined electrolytic salts at the predetermined ratios, whereby a film having small resistance to Li and having a sufficient film thickness has been formed on the surface of the negative electrode 30.

Hitherto, the embodiments have been described in detail with reference to the drawings, but each configuration, a combination thereof, and the like in each embodiment are simply examples, and addition, omission, substitution, and other modifications of the configuration are possible within the scope of the gist of the embodiments.

### EXAMPLE

### Example 1

A positive electrode slurry was applied to one surface of an aluminum foil having a thickness of 15 μm. The positive electrode slurry was produced by mixing a positive electrode active material, a conductive aid, a binder, and a solvent.

As the positive electrode active material, LiNi_{0.92}Co_{0.04}Mn_{0.04} as a lithium oxide was used. As the conductive aid, acetylene black was used. As the binder, polyvinylidene fluoride (PVDF) was used. As the solvent, N-methyl-2-pyrrolidone was used. The mass ratio of the positive electrode active material, the conductive aid, and the binder was set to 90 wt %: 5 wt %: 5 wt %. These were mixed in the solvent to produce the positive electrode slurry. The amount of the positive electrode active material supported in a dried positive electrode active material layer was 25 mg/cm². The solvent was removed from the positive electrode slurry in a drying furnace to produce the positive electrode active material layer. The positive electrode active material layer was pressurized with a roll press to produce a positive electrode.

A negative electrode slurry was applied to one surface of a copper foil having a thickness of 10 μm. The negative electrode slurry was produced by mixing a negative electrode active material, a conductive aid, a binder, and a solvent.

As the negative electrode active material, a graphite particle and a silicon material particle containing a carbon powder supported by the surface of a silicon powder were used. As the conductive aid, acetylene black was used. As the binder, polyvinylidene fluoride (PVDF) was used. As the solvent, N-methyl-2-pyrrolidone was used. The mass ratio of the negative electrode active material, the conductive aid, and the binder was set to 94 wt %: 2 wt %: 4 wt %. These were mixed in the solvent to produce the negative electrode slurry. The amount of the negative electrode active material supported in a dried negative electrode active material layer was 6.1 mg/cm². The solvent was removed from the negative electrode slurry in a drying furnace to produce the negative electrode active material layer. The negative electrode active material layer was pressurized with the roll press to produce a negative electrode. As a result of evaluating a negative electrode produced under the same conditions, the volume ratio of the silicon material particle was 50.5 vol %, and the volume ratio of the graphite particle was 49.5 vol %. In addition, the weight ratio of a silicon element to the negative electrode active material layer was 10.2 wt %.

Next, a non-aqueous electrolyte solution was produced. As a solvent for the non-aqueous electrolyte solution, ethylene carbonate (EC):ethyl methyl carbonate (EMC):diethyl carbonate (DEC) were set to 30 vol %:50 vol %:20 vol %. In addition, to an electrolytic solution, LiPF₆, LiFSI, and LiNO₃ were added as electrolytic salts. The molar ratio of LiNO₃ to LiPF₆ was set to 0.15, and the molar ratio of LiFSI to LiPF₆ was set to 0.30.

### (Production of Lithium-Ion Secondary Battery for Evaluation)

The positive electrode and the negative electrode were laminated together with a separator (porous polyethylene sheet) therebetween such that the positive electrode active material layer and the negative electrode active material layer faced each other, thereby obtaining a power generation element. This power generation element was inserted into an exterior body of an aluminum-laminated film, and the exterior body was heat-sealed except one site in the periphery, thereby forming an opening portion. In addition, finally, the non-aqueous electrolyte solution was poured into the exterior body, the power generation element was then heated to 60° C. and held for approximately two hours, and the remaining one site was sealed by heat sealing with a vacuum sealing machine while the exterior body was decompressed.

Next, the power generation element was charged and discharged for the first time. The initial charging and discharging were performed in two stages. First, the power generation element was charged for two hours by constant-current charging at a charging rate of 0.1 C (a current value at which the power generation element was completely charged within five hours when constant-current charged at 25° C.) and then charged at a charging rate of 0.2 C until the battery voltage reached 4.3 V. In addition, the power generation element was held for 10 minutes in a constant voltage state where the battery voltage was 4.3 V. After that, the power generation element was discharged by constant-current discharging at a discharging rate of 0.2 C until the battery voltage reached 2.0 V. In addition, after the initial charging and discharging, the power generation element was heated to 30° C., and the same charging and discharging as described above were further performed one more time. In addition, the discharge capacity after the end of the initial charging and discharging was detected, and a battery capacity Q₁ at the time of the initial discharging was obtained.

(Measurement of Capacity Retention after 100 Cycles)

The cycle characteristics of lithium-ion secondary batteries were measured. The cycle characteristics were measured using a secondary battery charge/discharge tester (manufactured by Meiden Hokuto Corporation). The cycle characteristics were measured in a low-temperature environment where the environmental temperature was 25° C. and in a high-temperature environment where the environmental temperature was 45° C., respectively. A lithium-ion secondary battery used in the measurement in the low-temperature environment and a lithium-ion secondary battery used in the measurement in the high-temperature environment are different samples produced under the same conditions.

At the time of measuring the cycle characteristics, 100 cycles of charging and discharging were performed. In each cycle, the lithium-ion secondary battery was charged by constant-current charging at a charging rate of 2.0 C until the battery voltage reached 4.3 V and discharged by constant-current discharging at a discharging rate of 4.0 C until the battery voltage reached 2.5 V. The discharge capacity after the end of 100 cycles of charging and discharging was detected, and a battery capacity Q₂ after 100 cycles was obtained.

A capacity retention E after 100 cycles was obtained from the above-obtained capacities Q₁ and Q₂. The capacity retention E was obtained by E=Q₂/Q₁×100. The capacity retention of the lithium-ion secondary battery of Example 1 under the low-temperature environment was 93%, and the capacity retention of the lithium-ion secondary battery of Example 1 under the high-temperature environment was 85%.

In addition, the lithium-ion secondary battery that had been charged and discharged 100 cycles (25° C.) was disassembled, and the surface of the negative electrode was analyzed by XPS. In addition, the intensity ratio of a second peak p2 to a first peak p1 in an S2p spectrum, the intensity ratio of a fourth peak to a third peak in an F1s spectrum, and the intensity ratio of a sixth peak to a fifth peak in a C1s spectrum were obtained.

### Examples 2 to 10

Examples 2 to 10 are different from Example 1 in terms of the fact that the molar ratios among LiPF₆, LiFSI, and LiNO₃ in the non-aqueous electrolyte solutions were changed and the abundance ratios between the silicon material particle and the graphite particle in the negative electrode active materials were changed. The other conditions were set to be the same as those in Example 1, and the cycle characteristics and XPS analyses were performed. The compositions of films that were formed on the negative electrodes in Examples 2 to 10 are different from that in Example 1 since the molar ratios among LiPF₆, LiFSI, and LiNO₃ were different. The relationships among the intensity ratios of the peaks obtained by XPS in Examples 2 to 10 are different from those in Example 1.

### Examples 11 to 18

Examples 11 to 18 are different from Example 1 in terms of the fact that the molar ratios among LiPF₆, LiFSI, and LiNO₃ in the non-aqueous electrolyte solutions were changed and the charging and discharging conditions at the time of the initial charging and discharging were changed. In Examples 13 and 14, the step of heating and holding the power generation element after the pouring of the non-aqueous electrolyte solution was not performed. In Examples 15 and 16, in the initial charging and discharging, the constant-current charging and the constant-current discharging were performed with the charging rate in the second stage changed to 0.7 C. In Examples 17 and 18, the step of charging and discharging the power generation element in a heated state after the initial charging and discharging was not performed. The other conditions were set to be the same as those in Example 1, and the cycle characteristics and XPS analyses were performed.

### Examples 19 to 21

In Examples 19 to 21, the molar ratios among LiPF₆, LiFSI, and LiNO₃ in the non-aqueous electrolyte solutions were fixed, and the abundance ratios between the silicon material particle and the graphite particle in the negative electrode active materials were changed. In Examples 19 to 21 as well, the cycle characteristics and XPS analyses were performed in the same manner as in Example 1.

### Comparative Examples 1 to 8

Comparative Examples 1 to 8 are different from Example 1 in terms of the fact that the molar ratios among LiPF₆, LiFSI, and LiNO₃ in the non-aqueous electrolyte solutions were changed.

In Comparative Example 1, LiNO₃ was not added to the non-aqueous electrolyte solution.

In Comparative Example 2, LiNO₃ was excessively added to the non-aqueous electrolyte solution.

In Comparative Example 3, LiFSI was not added to the non-aqueous electrolyte solution.

In Comparative Example 4, LiNO₃ and LiFSI were not added to the non-aqueous electrolyte solution.

In Comparative Example 5, LiFSI was excessively added to the non-aqueous electrolyte solution.

In Comparative Example 6, LiNO₃ and LiPF₆ were not added to the non-aqueous electrolyte solution.

In Comparative Example 7, LiFSI was not added to the non-aqueous electrolyte solution, and the amount of LiNO₃ added was also small.

In Comparative Example 8, LiNO₃ was not added to the non-aqueous electrolyte solution, and the amount of LiFSI added was also small.

The conditions and the measurement results of Examples 1 to 21 and Comparative Examples 1 to 8 are summarized in Table 1.

TABLE 1

| | | | | | | | Si | | Si weight | | |
|---|---|---|---|---|---|---|---|---|---|---|---|
| | Molar | Molar | | | | | material | Gr | ratio in | 25° C. | 45° C. |
| | ratio | ratio | | S2p | F1s | C1s | particle | particle | active | capacity | capacity |
| | (LiNO₃/ | (LiFSI/ | LiPF₆ | intensity | intensity | intensity | (volume | (volume | material | retention | retention |
| | LiPF₆) | LiPF₆) | (mol/l) | ratio | ratio | ratio | ratio) | ratio) | layer | (%) | (%) |
| Example 1 | 0.15 | 0.3 | 1.0 | 2.23 | 1.89 | 3.32 | 50.5 | 49.5 | 10.2 | 93 | 85 |
| Example 2 | 0.01 | 1.0 | 1.0 | 0.90 | 1.62 | 2.22 | 50.5 | 49.5 | 10.2 | 83 | 72 |
| Example 3 | 0.03 | 0.1 | 1.0 | 2.49 | 1.87 | 3.29 | 50.5 | 49.5 | 10.2 | 94 | 90 |
| Example 4 | 0.01 | 1.0 | 1.0 | 0.95 | 1.54 | 2.98 | 50.5 | 49.5 | 10.2 | 91 | 81 |
| Example 5 | 0.02 | 0.1 | 1.0 | 0.50 | 1.44 | 5.12 | 5.4 | 94.6 | 0.12 | 83 | 75 |
| Example 6 | 0.03 | 1.0 | 1.0 | 4.00 | 4.11 | 1.79 | 5.4 | 94.6 | 0.12 | 82 | 74 |
| Example 7 | 0.02 | 0.2 | 1.0 | 0.45 | 1.50 | 5.08 | 5.4 | 94.6 | 0.12 | 92 | 83 |
| Example 8 | 0.02 | 1.0 | 1.0 | 4.22 | 4.00 | 1.87 | 5.4 | 94.6 | 0.12 | 85 | 78 |
| Example 9 | 0.02 | 0.3 | 1.0 | 0.33 | 0.90 | 2.00 | 5.4 | 94.6 | 0.12 | 81 | 72 |
| Example 10 | 0.01 | 1.0 | 1.0 | 0.43 | 1.29 | 5.00 | 5.4 | 94.6 | 0.12 | 89 | 81 |
| Example 11 | 0.10 | 0.8 | 1.0 | 3.50 | 2.55 | 3.55 | 50.5 | 49.5 | 10.2 | 98 | 93 |
| Example 12 | 0.12 | 0.9 | 1.0 | 3.15 | 3.25 | 2.55 | 50.5 | 49.5 | 10.2 | 97 | 93 |
| Example 13 | 0.01 | 0.1 | 1.0 | 0.45 | 1.65 | 4.50 | 50.5 | 49.5 | 10.2 | 79 | 69 |
| Example 14 | 0.15 | 1.0 | 1.0 | 4.05 | 3.95 | 2.50 | 50.5 | 49.5 | 10.2 | 78 | 67 |
| Example 15 | 0.01 | 0.1 | 1.0 | 0.55 | 1.45 | 4.50 | 50.5 | 49.5 | 10.2 | 77 | 66 |
| Example 16 | 0.15 | 1.0 | 1.0 | 3.95 | 4.05 | 2.50 | 50.5 | 49.5 | 10.2 | 78 | 69 |
| Example 17 | 0.15 | 1.0 | 1.0 | 3.95 | 3.95 | 1.95 | 50.5 | 49.5 | 10.2 | 76 | 67 |
| Example 18 | 0.01 | 0.1 | 1.0 | 0.55 | 1.65 | 5.05 | 50.5 | 49.5 | 10.2 | 78 | 68 |
| Example 19 | 0.10 | 0.5 | 1.0 | 0.40 | 1.20 | 1.60 | 10.0 | 90.0 | 1.00 | 80 | 73 |
| Example 20 | 0.10 | 0.5 | 1.0 | 4.05 | 4.20 | 5.20 | 100 | 0 | 50 | 75 | 72 |
| Example 21 | 0.10 | 0.5 | 1.0 | 0.50 | 1.52 | 2.20 | 5.4 | 94.6 | 0.12 | 75 | 75 |
| Comparative | 0 | 0.5 | 1.0 | 0.40 | 1.20 | 1.80 | 5.4 | 94.6 | 0.12 | 69 | 60 |
| Example 1 | | | | | | | | | | | |
| Comparative | 0.18 | 0.4 | 1.0 | 0.30 | 0.85 | 1.20 | 5.4 | 94.6 | 0.12 | 70 | 59 |
| Example 2 | | | | | | | | | | | |
| Comparative | 0.1 | 0.0 | 1.0 | 0.30 | 0.90 | 1.20 | 5.4 | 94.6 | 0.12 | 71 | 61 |
| Example 3 | | | | | | | | | | | |
| Comparative | 0 | 0.0 | 1.0 | 0.30 | 0.85 | 5.10 | 5.4 | 94.6 | 0.12 | 67 | 57 |
| Example 4 | | | | | | | | | | | |
| Comparative | 0.1 | 1.2 | 1.0 | 4.40 | 4.20 | 1.00 | 5.4 | 94.6 | 0.12 | 71 | 62 |
| Example 5 | | | | | | | | | | | |
| Comparative | 0 | 1.0 | 0.0 | 4.60 | 4.10 | 1.80 | 5.4 | 94.6 | 0.12 | 70 | 61 |
| Example 6 | | | | | | | | | | | |
| Comparative | 0.005 | 0.0 | 1.0 | 0.40 | 1.00 | 1.70 | 5.4 | 94.6 | 0.12 | 67 | 57 |
| Example 7 | | | | | | | | | | | |
| Comparative | 0 | 0.05 | 1.0 | 0.35 | 1.10 | 1.90 | 5.4 | 94.6 | 0.12 | 66 | 55 |
| Example 8 | | | | | | | | | | | |

Compared with Comparative Examples 1 to 8, Examples 1 to 21 were excellent in terms of the cycle characteristics both under the low-temperature environment and under the high-temperature environment. This is considered to be because the ratios of the electrolytic salts that were contained in the non-aqueous electrolyte solutions were within the predetermined ranges, whereby desired films were formed on the surfaces of the negative electrodes. The films had a sufficient thickness, whereby it was possible to curb a reaction between the electrolytic solution and the negative electrode caused by the thermal decomposition of the film even under high-temperature environments. In addition, the resistance of the films to Li ions did not become too high, whereby the precipitation of Li can be curbed.

In addition, compared with Examples 13 to 18, Examples 1 to 4 and Examples 10 and 11 were excellent in terms of the cycle characteristics both under low-temperature environments and under high-temperature environments. It is considered that not only the molar ratios among LiPF₆, LiFSI, and LiNO₃ in the non-aqueous electrolyte solutions but the states of the films that were measured by XPS were also controlled, whereby the cycle characteristics of the lithium-ion secondary batteries improved.

While embodiments have been described and illustrated above, it should be understood that these are exemplary and are not to be considered as limiting. Additions, omissions, substitutions, and other modifications can be made without departing from the spirit or scope of the embodiments. Accordingly, the invention is not to be considered as being limited by the foregoing description, and is only limited by the scope of the appended claims.

### EXPLANATION OF REFERENCES

10 Separator
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Lithium-ion secondary battery

What is claimed is:

1. A non-aqueous electrolyte solution comprising:
lithium hexafluorophosphate;
lithium bis(fluorosulfonyl)imide; and
lithium nitrate,
wherein a molar ratio of the lithium nitrate relative to a molar ratio of the lithium hexafluorophosphate is 0.01 or more and 0.15 or less, and
wherein a molar ratio of the lithium bis(fluorosulfonyl)imide relative to a molar ratio of the lithium hexafluorophosphate is 0.1 or more and 1.0 or less.

2. The non-aqueous electrolyte solution according to claim 1, further comprising a non-aqueous solvent.

3. The non-aqueous electrolyte solution according to claim 2, wherein the non-aqueous solvent includes an aprotic organic solvent.

4. The non-aqueous electrolyte solution according to claim 2, wherein the non-aqueous solvent includes a cyclic carbonate, a linear carbonate, or an ether.

5. The non-aqueous electrolyte solution according to claim 4, wherein:
the non-aqueous solvent includes the cyclic carbonate, and
the cyclic carbonate includes ethylene carbonate, propylene carbonate, butylene carbonate, or fluoroethylene carbonate.

6. The non-aqueous electrolyte solution according to claim 4, wherein:
the non-aqueous solvent includes the linear carbonate, and
the linear carbonate includes diethyl carbonate, dimethyl carbonate, or ethyl methyl carbonate.

7. The non-aqueous electrolyte solution according to claim 2, wherein the non-aqueous solvent includes methyl acetate, ethyl acetate, methyl propionate, ethyl propionate, propyl propionate, γ-butyrolactone, 1,2-dimethoxyethane, or 1,2-diethoxyethane.

8. The non-aqueous electrolyte solution according to claim 2, wherein the non-aqueous solvent includes ethylene carbonate (EC), ethyl methyl carbonate (EMC), and diethyl carbonate (DEC) in a volume ratio of 30 EC:50 EMC:20 DEC.

9. A lithium-ion secondary battery comprising:
a positive electrode;
a negative electrode;
a separator between the positive electrode and the negative electrode; and
the non-aqueous electrolyte solution according to claim 1.

10. The lithium-ion secondary battery according to claim 9, wherein:
an S2p spectrum that is obtained by measuring a surface of the negative electrode using X-ray photoelectron spectroscopy (XPS) has a first peak that is observed in a binding energy range of 165 eV or higher and 175 eV or lower and a second peak that is observed in a binding energy range of 155 eV or higher and 165 eV or lower, and
an intensity ratio of the second peak to the first peak is 0.5 or more and less than 4.0.

11. The lithium-ion secondary battery according to claim 9, wherein:
an F1s spectrum that is obtained by measuring a surface of the negative electrode using X-ray photoelectron spectroscopy (XPS) has a third peak that is observed in a binding energy range of 686 eV or higher and 690 eV or lower and a fourth peak that is observed in a binding energy range of 682 eV or higher and 686 eV or lower, and
an intensity ratio of the fourth peak to the third peak is 1.5 or more and less than 4.0.

12. The lithium-ion secondary battery according to claim 9, wherein:
a C1s spectrum that is obtained by measuring a surface of the negative electrode using X-ray photoelectron spectroscopy (XPS) has a fifth peak that is observed in a binding energy range of 288 eV or higher and 292 eV or lower and a sixth peak that is observed in a binding energy range of 280 eV or higher and 288 eV or lower, and
an intensity ratio of the sixth peak to the fifth peak is 2.0 or more and less than 5.0.

13. The lithium-ion secondary battery according to claim 9, wherein:
the negative electrode includes a negative electrode active material layer containing a negative electrode active material,
the negative electrode active material contains at least one of a silicon material particle and a graphite particle, and
an amount of the silicon material particle in the negative electrode active material is 10 vol % or more and 100 vol % or less, based on a total volume of the negative electrode active material.

14. The lithium-ion secondary battery according to claim 13, wherein the silicon material particle includes Si, SiC, SiOₓ, in which x satisfies: 0.8≤x≤2.0, or MSi, in which Mis an alkaline earth metal or a transition metal.

15. The lithium-ion secondary battery according to claim 9, wherein:
the negative electrode includes a negative electrode active material layer containing a silicon material particle, and
an amount of a silicon element in the negative electrode active material layer is 1 wt % or more and 50 wt % or less, based on a total weight of the negative electrode active material layer.

16. The lithium-ion secondary battery according to claim 15, wherein the silicon material particle includes Si, SiC, SiOₓ, in which x satisfies: 0.8≤x≤2.0, or MSi, in which Mis an alkaline earth metal or a transition metal.

17. The lithium-ion secondary battery according to claim 9, wherein the negative electrode includes a negative electrode active material layer containing a negative electrode active material and at least one of a conductive aid or a binder.

18. The lithium-ion secondary battery according to claim 17, wherein:
the negative electrode active material layer includes the conductive aid, and
the conductive aid includes a carbon powder, carbon nanotubes, a carbon material, a fine metal powder, or a conductive oxide.

19. The lithium-ion secondary battery according to claim 17, wherein:
the negative electrode active material layer includes the binder, and
the binder includes polyvinylidene fluoride (PVDF), polytetrafluoroethylene (PTFE), polyamide (PA), polyimide (PI), polyamide-imide (PAI), polybenzimidazole (PBI), polyethersulfone (PES), a polyacrylic acid or a copolymer thereof, a metal ion cross-linked polyacrylic acid or a copolymer thereof, or polypropylene (PP) or polyethylene (PE) to which a maleic anhydride has been grafted.

20. The lithium-ion secondary battery according to claim 17, wherein:
an amount of the conductive aid included in the negative electrode active material layer is 5 mass % or more and 20 mass % or less, based on a total mass of the negative electrode active material layer, and
an amount of the binder included in the negative electrode active material layer is 0.5 mass % or more and 20 mass % or less, based on the total mass of the negative electrode active material layer.
